(19) United States
(12) Patent Application Publication
(10) Pub. No.: US 2025/0286602 A1
(43) Pub. Date: Sep. 11, 2025

(54) MAXIMUM PERMISSIBLE EXPOSURE REPORTING

(71) Applicant: Nokia Technologies Oy, Espoo (FI)

(72) Inventors: Keeth Saliya Jayasinghe LADDU, Espoo (FI); Matha DEGHEL, Massy (FR); Samantha CAPORAL DEL BARRIO, Aalborg (DK); Sami-Jukka HAKOLA, Oulu (FI)

(21) Appl. No.: 18/862,840

(22) PCT Filed: May 13, 2022
(86) PCT No.: PCT/EP2022/063047

§ 371 Date: Nov. 4, 2024

(51) Int. Cl. H04B 7/06; H04W 24/10; H04W 52/02

(52) U.S. Cl. CPC H04B 7/06952; H04W 24/10; H04W 52/0235

(57) ABSTRACT

A method comprises selecting, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and transmitting, by the user device to a network node, a maximum permissible exposure (MPE) report comprising at least one power reduction value for at least one of the selected one or more beam pairs.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include selecting, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and transmitting, by the user device to a network node in the wireless network, a maximum permissible exposure (MPE) report comprising at least one power reduction value for at least one of the selected one or more beam pairs.

According to an example embodiment, an apparatus includes: at least one processor; and at least one memory including computer program code; the at least one memory and the computer program code configured to, with the at least one processor, cause the apparatus at least to: select, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and transmit, by the user device to a network node in the wireless network, a maximum permissible exposure (MPE) report comprising at least one power reduction value for at least one of the selected one or more beam pairs.

According to an example embodiment, an apparatus includes: A non-transitory computer-readable storage medium comprising instructions stored thereon that, when executed by at least one processor, are configured to cause a computing system to: select, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and transmit, by the user device to a network node in the wireless network, a maximum permissible exposure (MPE) report comprising at least one power reduction value for at least one of the selected one or more beam pairs.

According to an example embodiment, an apparatus comprises means for selecting, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and means for transmitting, by the user device to a network node in the wireless network, a maximum permissible exposure (MPE) report comprising at least one power reduction value for at least one of the selected one or more beam pairs.

According to an example embodiment, a method may include receiving, by a network node and from a user device in a wireless network, a maximum permissible exposure (MPE) report comprising at least one power reduction value for at least one beam pair; wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.

According to an example embodiment, an apparatus includes: at least one processor; and at least one memory including computer program code; the at least one memory and the computer program code configured to, with the at least one processor, cause the apparatus at least to: receive, by a network node and from a user device in a wireless network, a maximum permissible exposure (MPE) report comprising at least one power reduction value for at least one beam pair; wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.

According to an example embodiment, an apparatus includes: a non-transitory computer-readable storage medium comprising instructions stored thereon that, when executed by at least one processor, are configured to cause a computing system to: receive, by a network node and from a user device in a wireless network, a maximum permissible exposure (MPE) report comprising at least one power reduction value for at least one beam pair; wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.

According to an example embodiment, an apparatus includes: means for receiving, by a network node and from a user device in a wireless network, a maximum permissible exposure (MPE) report comprising at least one power reduction value for at least one beam pair; wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating multiple uplink transmissions or multi-TRP communication according to an example embodiment.

FIG. 3 is a flow chart illustrating operation of a UE (or user device) according to an example embodiment.

FIG. 4 is a flow chart illustrating operation of a network node according to an example embodiment.

FIG. 5 is a flow chart illustrating operation of a UE according to an example embodiment.

FIG. 6 is a flow chart illustrating operation of a UE according to an example embodiment.

FIG. 7 is a flow chart illustrating operation of a UE according to another example embodiment.

FIG. 8 is a block diagram of a wireless station (e.g., AP, BS, gNB, TRP, network node, user device, UE, or other wireless node) according to an example embodiment.

### DETAILED DESCRIPTION

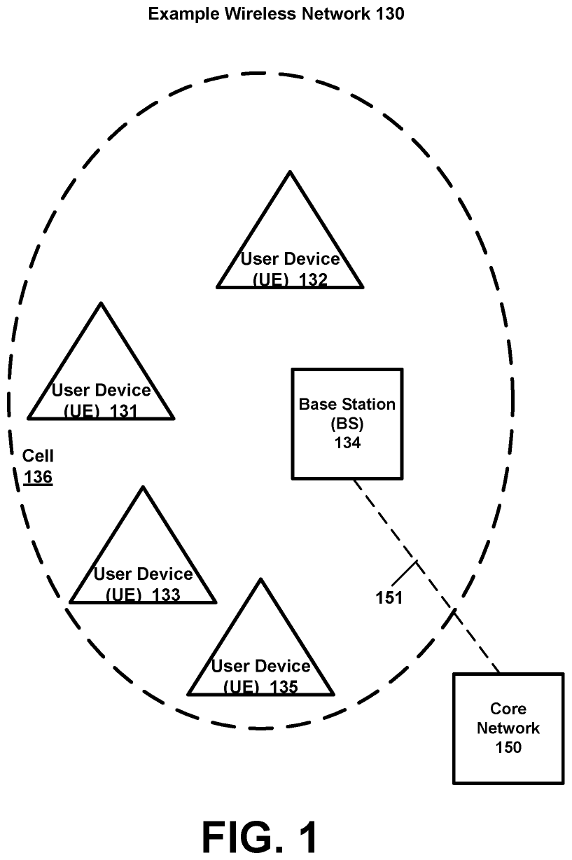

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), or a next generation Node B (gNB). The terms user device and user equipment (UE) may be used interchangeably. A BS may also be referred to as a RAN (radio access network) or NG-RAN (next generation radio access network) node. At least part of the functionalities of a BS (e.g., AP, gNB, eNB, RAN node) may also be carried out by one or more network nodes, servers or hosts, such as a centralized unit (CU) and a distributed unit (DU) in a split RAN architecture, which may be operably coupled to a remote transceiver, such as a remote radio head (RRH). BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

According to an illustrative example, a BS (e.g., AP, eNB, gNB, RAN node) may be part of a mobile telecommunication system. A RAN may include one or more RAN nodes (e.g., AP, BSs, eNBs, gNBs) that implement a radio access technology, e.g., to allow one or more UEs to have access to a network or core network. Thus, the RAN nodes reside between one or more user devices or UEs and a core network. According to an example embodiment, each RAN node may provide one or more wireless communication services for one or more UEs or user devices, e.g., to allow the UEs to have wireless access to a network, via the RAN node. Each RAN node may perform or provide wireless communication services, e.g., such as allowing UEs or user devices to establish a wireless connection to the RAN node, and sending data to and/or receiving data from one or more of the UEs. For example, after establishing a connection to a UE, a RAN node may forward data to the UE that is received from a network or the core network, and/or forward data received from the UE to the network or core network. RAN nodes may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node may perform.

A user device (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, a wearable device, as examples, or any other wireless device. It should be appreciated that a user device may also be (or may include) a nearly exclusive uplink only device, of which an example is a camera or video camera loading images or video clips to a network.

Core network 150 may include a mobility management entity (MME) or an access and mobility management function (AMF), which may control access to the network, and handle or assist with mobility/handover of user devices between BSs, one or more gateways that may forward data between the BSs and a packet data network or the Internet, and other control nodes, functions or blocks.

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a eMBB UE (or an eMBB application running on a UE).

The various example embodiments may be applied to a wide variety of wireless technologies or wireless networks, such as LTE, LTE-A, 5G/New Radio (NR), or any other wireless network or wireless technology operating on cmWave and/or mmWave bands, and to a wide variety of communication services, such as IoT, MTC, eMTC, eMBB, URLLC, etc. These example networks, technologies or data service types are provided only as illustrative examples.

A UE may be configured by a gNB (or other network node) to perform different measurements and measurement reporting to the network (or gNB(s)). A configuration of a UE to perform reference signal (or beam) measurement (e.g., such as CSI-RS measurement for different beams) and reporting may be performed by a gNB sending a report configuration (e.g., such as a CSI-Report-Config) to the UE. A report configuration, for example, may indicate downlink resource(s) on which measurements should be performed (e.g., CSI-RS reference signals/SSBs, or beams), specific quantities or parameters to be measured, and how the reporting is to be performed, such as when the reporting is done, etc.

A UE may measure a signal parameter(s) (e.g., such as a reference signal received power (RSRP)) of each of a plurality of downlink reference signals (e.g., such as synchronization signal block/SSB signals, or channel state information (CSI)-reference signals (CSI-RS)) received by the UE from the gNB/network node (or BS), where each reference signal may be transmitted by the gNB via a different gNB transmit beam (or via a different downlink DL reference signal). The UE may determine the strongest beams or reference signals (e.g., having a highest RSRP), and then may send a measurement report to the gNB that may identify the strongest N DL reference signals (or beams), and the RSRP (or other measured signal parameter) of these N beams, for example. The gNB may use this measurement report to determine what beam to use to communicate with the UE, for example.

According to an example embodiment, a PDCCH (physical downlink control channel) may be transmitted using 1, 2, 4, 8 or 16 contiguous control-channel elements (CCEs), where the number of CCEs may be referred to as the aggregation level (or CCE aggregation level). According to an example embodiment, a CCE is a building block of a PDCCH, where a CCE may be a smallest set of resources that can be used for a PDCCH. For example, a CCE may be a unit upon which search spaces for blind decoding may be defined. Thus, each PDCCH may include one or more CCEs, depending on the aggregation level. According to an example embodiment, a CCE may include 6 resource element groups (REGs), each of which may include one resource block in an OFDM symbol.

A search space may include a set of candidate PDCCHs (candidate downlink control channels) formed by CCEs at given aggregation level(s), which the UE is supposed to attempt to decode. A UE may have multiple search spaces for different purposes (such as different common search spaces, and user-specific search spaces). A search space may include one or more control resource sets (CORESETs). A CORESET may be (or may include) the time-frequency resources upon which a PDCCH(s) is transmitted. There can be multiple search spaces using a same control resource set (CORESET), and there can be multiple CORESETs configured for a UE. Also, a control resource set (CORESET) may be (or may include) time-frequency resources in which the UE tries to decode candidate PDCCHs using one or more search spaces.

In addition, transmission configuration indication (TCI) states may be used by a network node (gNB or BS) within a control resource set (or CORESET) to provide beam indications for the UE, which may identify a beam the UE should use for uplink communication and/or downlink communication with the network node or gNB. Each TCI state may be configured or associated with a transmit beam/receive beam pair. Thus, each TCI state may be associated with a particular beam or a specific reference signal. For example, TCI state 1 may be associated with (or may be used to indicate) CSI-RS #5, TCI state 2 may be associated with CSI-RS #9, etc. (where CSI-RS #5, and CSI-RS #9 may be DL reference signals transmitted by the gNB). Thus, in this manner, each TCI state may be associated (or the TCI state may indicate) with a specific reference signal and/or a specific beam. For example, for data transmission via a physical downlink shared channel (PDSCH) and/or via physical uplink shared channel (PUSCH), a UE may be configured by gNB via radio resource control (RRC) message with 128 candidate TCI states. Then, gNB may configure the UE with up to, e.g., 8 (or other number) activated TCI states via a MAC (media access control) control element (MAC CE) that may be piggy-backed (or appended to) a DL (downlink) data transmission to the UE via PDSCH (physical downlink shared channel). Thus, in this manner the gNB may send an activation message to activate (within the UE) the 8 (for example) indicated TCI states of the 128 (for example) candidate TCI states. The UE may be requested by the network node to use a beam associated with any of these 8 (or other number) activated TCI states for communication with the network node or gNB (e.g., for transmitting or receiving data).

Dynamically (e.g., such as provided within downlink control information/DCI of each subframe or slot), the gNB may indicate a selection of one of the activated TCI states (and thus, identify a selected beam) for the UE to use for an uplink or downlink data communication (e.g., for a scheduled uplink (UL) or downlink (DL) communication, via PDSCH and/or PUSCH). The DCI (which may, at least in some cases, identify a selected activated TCI state for the UE to use for a communication) may be provided within the PDCCH (physical downlink control channel) transmitted to the UE, e.g., as part of each slot or subframe. In this manner, in some cases, the DCI may be used to provide a fast beam indication, that indicates a selected TCI state (e.g., of a plurality of activated TCI states) that is associated with a reference signal or beam to be used by the UE for UL or DL data communication with the network node (BS or gNB). A UE may also receive control information (e.g., via radio resource control (RRC) message) indicating a selected TCI state (and thus, beam) to be used by the UE to receive a PDCCH for a CORESET. Thus, a CORESET may be configured with a TCI state.

Release 16 of NR provided support for single cell downlink multi-transmission reception points (multi-TRP) (or multiple transmission points), which provides the possibility of downlink data to be transmitted via PDSCH (physical downlink shared channel) simultaneously from two different transmission reception points (TRPs), which may be separated geographically, but are provided within the same cell (e.g., transmissions of downlink data from two different radio heads or other nodes to a UE within a cell).

In addition, Rel-17 introduced a unified TCI framework meaning that TCI states providing QCL assumptions for the reception of DL signals and channels would be used also to provide spatial sources for the transmission of UL signals and channels. Furthermore, the unified TCI framework defines the concept of indicated TCI state. The indicated TCI state can be joint DL and UL TCI state or separate DL and separate UL TCI states. Indicated TCI state provides QCL source (DL) and spatial source (UL) for the set of downlink signals and channels and for the set of uplink signals and channels, respectively. In Rel-17 there can be one indicated joint DL and UL or one indicated DL and one indicated UL TCI state for the UE.

For example, a unified TCI framework may include the following functionalities at a high level: a common TCI state (e.g., indicated TCI) for a set of signals and channels at a time; a TCI state can be joint DL/UL TCI state, separate DL TCI state and/or a separate UL TCI state; RRC configures set (or pool) of joint and/or separate TCI states; MAC (media access control entity) activates a number (e.g., 8) of joint and/or separate TCI states; before first indication, first activated TCI state is the current indicated TCI state; DCI (downlink control information, e.g., provided by gNB via physical downlink control channel (PDCCH) to UE) indicates one of the activated TCI states to be indicated TCI state (which may be a common TCI state); on the DCI-based TCI state indication: DCI format 1_1/1_2 with and without DL assignment may be used to carry the TCI state indication; an indication confirmed by HARQ ACK (HARQ acknowledgement feedback, to acknowledge data received by UE) by UE; application time of the beam indication: the first slot that is at least X ms or Y symbols after the last symbol of the acknowledgment of the joint or separate DL/UL beam indication; TCI field codepoint: Joint: TCI state for both DL and UL; Separate: a pair of DL TCI state and UL TCI state; a DL TCI state (keep the current UL TCI state); an UL TCI state (keep the current DL TCI state); Unified TCI framework will be extended in Rel-18 so that there can be then multiple indicated DL and/or UL TCI states;

In addition, a UE may transmit uplink (UL) control information (UCI) to a gNB via a physical uplink control channel (PUCCH). UCI may include, e.g., one or more of: 1) Hybrid ARQ acknowledgement (HARQ-ACK) feedback for received downlink data (to acknowledge receipt of DL (downlink) data); 2) channel state information (CSI) related to downlink channel conditions, e.g., used by the gNB to assist downlink scheduling including multi-antenna and beamforming schemes; and/or, 3) scheduling requests indicating that the UE needs or is requesting uplink resources for an uplink transmission to the gNB (e.g., requesting a PUSCH allocation).

Furthermore, a UE may transmit data to a gNB or network node via a physical uplink shared channel (PUSCH). A valid scheduling grant or PUSCH allocation (which provides the UE with an allocation of time-frequency resources that may be used by the UE for UL transmission) may be required for the UE to transmit uplink data to the gNB.

Also, as used herein, the term beam or (UL) beam may also refer to spatial relation information, (separate) UL TCI state, joint or common TCI state, spatial filter, power control information (or power control parameters set), SRS (sounding reference signal) resource indicator (pointing to one or more SRS resources) panel or panel ID (e.g., antenna panel identifier), a quasi-colocation (QCL) information Type-D (or any other type), capability value set, etc.

Note that a UE panel (UE antenna panel) may be identified by an index of corresponding UE capability value set or by a panel ID (panel identifier). Alternatively, or additionally, a panel (or antenna panel) may be identified or associated by at least one reference signal (such as at least one downlink reference signal, such as SSB (synchronization signal block (SSB) reference signal, and/or channel state information-reference signal (CSI-RS)), or simply by an UL beam.

Release 18 may allow simultaneous PUSCH transmissions (e.g., transmission of two time-domain overlapping PUSCH transmissions), which may be transmitted to same or different transmission-reception points (TRPs), e.g., to same or different gNBs and in the same (serving) cell.

According to an example embodiment, a UE may perform different types of simultaneous transmissions, e.g., such as two PUCCH transmissions transmitted simultaneously, a PUSCH and a PUCCH transmissions transmitted simultaneously, two PUCCH transmissions transmitted simultaneously, a SRS and either a PUSCH or a PUCCH transmitted simultaneously, as examples. Also, the UE may transmit (or perform UL transmissions to) information (e.g., which may be simultaneous transmissions) or messages to two transmission reception points (TRPs), also known generally as multi-TRP, or perform transmissions. Similarly, a UE may perform transmissions (e.g., which may be simultaneous transmissions) via beams corresponding to different panels or capability value sets.

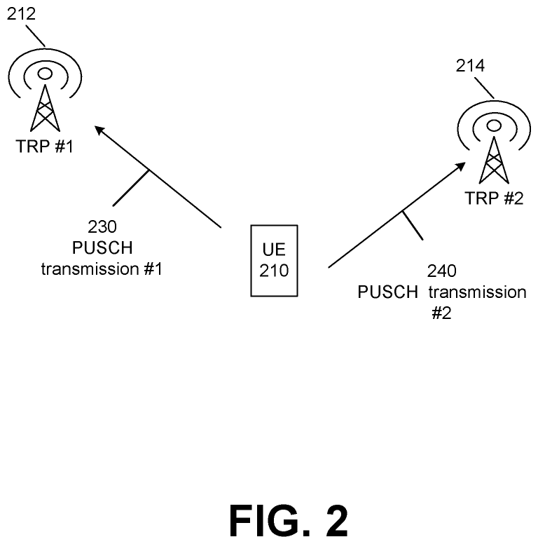

FIG. 2 is a diagram illustrating multiple simultaneous transmissions (or multi-TRP operation) according to an example embodiment. As shown in FIG. 2, a UE 210 may be in communication with (and/or may be connected to) one or both of the transmission-reception points (TRPs) 212 and/or 214. TRPs 212 and 214 may be gNBs or other network nodes. In the example of FIG. 2, UE 210 performs multiple simultaneous transmissions, e.g., such as two simultaneous (or overlapping in time domain) PUSCH transmissions, including PUSCH transmission #1 (230) to TRP #1 (212) and PUSCH transmission #2 (240) to TRP #2 (214). This is an illustrative example of multiple simultaneous transmissions or transmissions to multiple TRPs.

The Federal Communication Commission (FCC) has approved or provided a MPE (Maximum Permissible Exposure) regulation that defines regulatory requirements and limits as to how much power portable devices (e.g., such as UEs) at frequencies above 6 GHz (like at FR2 frequencies and beyond) may transmit when a human body is in close proximity of the devices. FR2 NR UEs are allowed to reduce their transmit power as much as necessary using P-MPR (Power Management Maximum Power Reduction) to meet the MPE regulatory requirements. In case of large UE transmit power reduction or backoff, such as in case of a large P-MPR value (large power reduction value), the gNB may no longer receive UE's transmitted signaling, which unfortunately, may cause unpredictable radio link failures and thus, even connection releases.

To reduce radio link failures, e.g., such as in cases of MPE, a UE may perform an event-triggered reporting for MPE issue (or MPE event), where the UE may report (e.g., via transmitting a MPE report) that it requires P-MPR (UE transmit power backoff) due to MPE (Maximum Permissible Exposure) reasons, via transmission of a PHR report in MAC, which may indicate the occurrence of a MPE or MPE event at the UE. The MPE report transmitted by the UE may indicate, e.g., up to 4 P-MPR values (or power reduction values), wherein each P-MPR value may indicate a (e.g., maximum) power backoff or power reduction by the UE for this beam for UL transmission for a candidate beam, identified by either SSBRI (synchronization signal block resource indicator) or CRI (channel state information-reference signal resource indicator). These reported beams and P-MPR values may offer alternative beams for the UE, which may allow the UE to avoid such a large power reduction that may be required for a currently used beam. Thus, the gNB may perform one or more actions, including requesting (or signalling to) the UE to use one of the reported candidate beams for communication, e.g., to avoid such a large power reduction at the UE (in response to the MPE). Thus, the MPE report may, at least in some cases, improve uplink transmission performance in the event of a detected MPE at the UE.

While the UE may transmit a MPE report, including power reduction (e.g., P-MPR or any other MPR related parameter) values for one or more candidate beams, these candidate beams may not be suitable for simultaneous transmissions or transmissions to multiple transmission reception points (multi-TRP operation). Therefore, currently, the gNB has no way to determine which of the beams, if any, that were reported in the MPE report, may be suitable for simultaneous transmissions or for transmissions to multiple TRPs, or for multiple transmissions via beams corresponding to different panels or capability value sets of the UE. Thus, the current MPE reporting structure (e.g., after a MPE event is detected by the UE) is unable to accommodate or support multiple simultaneous transmissions, or transmitting to multiple TRPs, and/or multiple transmissions via beams corresponding to different panels or capability value sets of the UE.

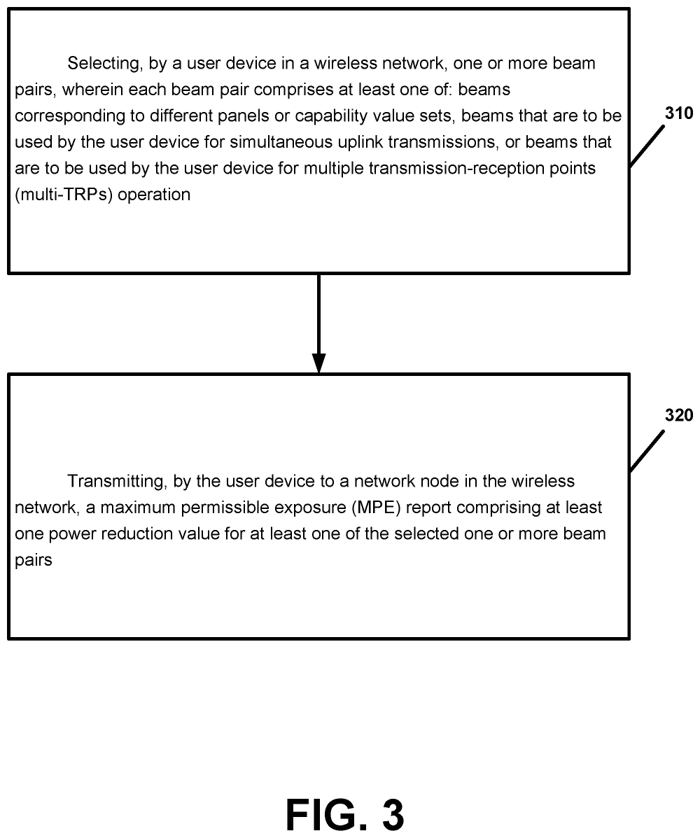

FIG. 3 is a flow chart illustrating operation of a UE (or user device) according to an example embodiment. Operation 310 includes selecting, by a user device (e.g., UE 210) in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation. And, operation 320 includes transmitting, by the user device to a network node (e.g., gNB or TRP) in the wireless network, a maximum permissible exposure (MPE) report comprising at least one power reduction value (e.g., P-MPR value) for at least one of the selected one or more beam pairs.

According to an example embodiment of the method of FIG. 3, the selecting the one or more beam pairs may comprise determining a set of beam pairs, wherein each beam pair of the set of beam pairs includes at least one of: beams corresponding to different panels or capability value sets, beams that are to be used by the user device for simultaneous uplink transmissions, or beams that are to be used by the user device for multiple transmission-reception points (multi-TRPs) operation; and selecting, by the user device, the one or more beam pairs among the set of beam pairs.

According to an example embodiment of the method of FIG. 3, the determining the set of beam pairs may be performed by the user device based on a first indication from the network node or based on one or more first rules; and the selecting the one or more beam pairs among the set of beam pairs may be performed by the user device based on a second indication from the network node or based on one or more second rules. The first indication and/or first rules may be the same as or different from the second indication and/or second rules. Also, for example, the at least one power reduction value for the at least one of the selected one or more beam pairs may include at least one Power Management-Maximum Power Reduction (P-MPR) value.

According to an example embodiment of the method of FIG. 3, the at least one power reduction value may include at least one of: a power reduction value for one of beams of at least one beam pair of the selected one or more beam pairs; a power reduction value for each beam of at least one beam pair of the selected one or more beam pairs; or a joint power reduction value for at least one beam pair of the selected one or more beam pairs. Also, for example, each beam of a beam pair may include or may be associated with a reference signal (e.g., SSB or CSI-RS reference signal) or a transmission configuration indication (TCI) state.

According to an example embodiment of the method of FIG. 3, the determining the set of beam pairs based on the first indication from the network node or based on the one or more first rules may comprise: receiving, by the user device from the network node, a configuration or the first indication that indicates the set of beam pairs, wherein each beam pair of the set of beam pairs comprises at least one of: beams corresponding to different panels or capability value sets, beams that are to be used by the user device to transmit simultaneous uplink transmissions, or beams that are to be used by the user device to transmit to multiple transmission-reception points (multi-TRPs).

According to an example embodiment of the method of FIG. 3, the determining, based on the first indication from the network node or based on the one or more first rules, the set of beam pairs comprises: determining, by the user device, a first subset of beams associated with a first panel or capability value set, and a second subset of beams associated with a second panel or capability value set; and determining the set of beam pairs, wherein each beam pair of the set of beam pairs comprises a beam from the first subset of beams and a beam from the second subset of beams.

According to an example embodiment of the method of FIG. 3, the determining, based on the first indication from the network node or based on the one or more first rules, the first subset of beams and the second subset of beams may comprise: receiving, by the user device from the network node, information or a configuration indicating a pool of beams; and separating the beams, by the user device among the pool of beams, into the first subset of beams associated with the first panel or capability value set, and the second subset of beams associated with the second panel or capability value set.

According to an example embodiment of the method of FIG. 3, the determining, based on the first indication from the network node or based on the one or more first rules, the first subset of beams and the second subset of beams may comprise: receiving, by the user device from the network node, information or a configuration indicating the first subset of beams associated with the first panel or capability value set, and the second subset of beams associated with the second panel or capability value set.

According to an example embodiment, the selecting the one or more beam pairs among the set of beam pairs based on the second indication from the network node or based on the one or more second rules may comprise performing at least one of the following:
selecting the beam pairs of the set of beam pairs; selecting a beam pair, within the set of beam pairs, if at least one beam in the beam pair has a power reduction value above or below a threshold; selecting a beam pair, within the set of beam pairs, if beams in the beam pair have power reduction values above or below the threshold; or selecting a beam pair, within the set of beam pairs, if beams in the beam pair have a joint power reduction value above or below a threshold.

According to an example embodiment of the method of FIG. 3, the transmitting, by the user device to the network node, the maximum permissible exposure (MPE) report comprising the at least one power reduction value for the at least one of the selected one or more beam pairs may comprise at least one of the following: transmitting the MPE report comprising power reduction values of a first beam and a second beam for a beam pair of the at least one of the selected one or more beam pairs, wherein the beam pair comprises the first beam and the second beam; transmitting the MPE report comprising at least one power reduction value for a beam pair of the at least one of the selected one or more beam pairs, if at least one beam of the beam pair has a power reduction value greater than a first threshold or less than a second threshold; transmitting the MPE report comprising a joint power reduction value for a beam pair of the at least one of the selected one or more beam pairs, wherein the joint power reduction value is based on at least one of: 1) a sum of power reduction values of beams of the beam pair, 2) a maximum or a minimum or a highest or lowest power reduction value of the power reduction values of beams of the beam pair, 3) a power reduction value for one beam of the beam pair and a power reduction offset for other beam of the beam pair, and/or 4) a function or relationship of two power reduction values of beams of the beam pair.

According to an example embodiment of the method of FIG. 3, the MPE report may comprise at least one of the following: for a beam pair of the at least one of the selected one or more beam pairs, an indication of whether at least one power reduction value is comprised in the MPE report for the beam pair; or a number of beam pairs of the at least one of the selected one or more beam pairs for which at least one power reduction value is comprised in the MPE report.

According to an example embodiment of the method of FIG. 3, the method may further comprise receiving, by the user device and from the network node, control information indicating one of the at least one selected beam pairs to be for simultaneous uplink transmissions; and, performing, by the user device and based on the indicated beam pair, at least one of the following: performing, by the user device, simultaneous uplink transmissions using beams of the indicated beam pair; performing, by the user device, uplink transmissions to multiple transmission-reception points (multi-TRPs) using beams of the indicated beam pair; and/or performing, by the user device, uplink transmissions via beams of the indicated beam pair, wherein the beams of the beam pair correspond to different panels or capability value sets.

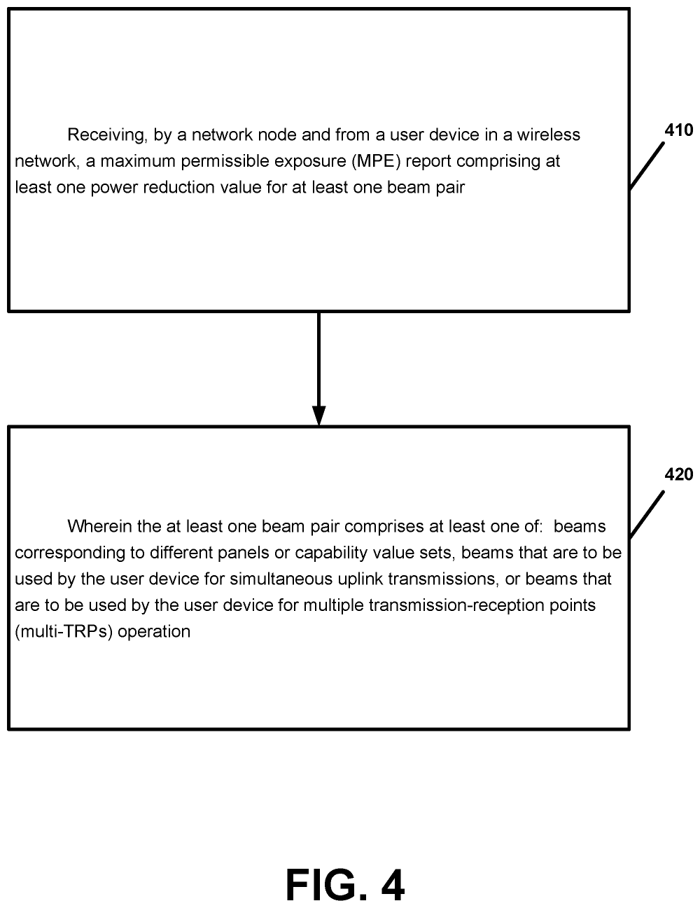

FIG. 4 is a flow chart illustrating operation of a network node according to an example embodiment. Operation 410 includes receiving, by a network node (e.g., gNB or TRP) and from a user device (e.g., UE) in a wireless network, a maximum permissible exposure (MPE) report comprising at least one power reduction value (e.g., P-MPR value) for at least one beam pair; wherein the at least one beam pair includes at least one of: beams corresponding to different panels or capability value sets, beams that are to be used by the user device for simultaneous uplink transmissions, or beams that are to be used by the user device for multiple transmission-reception points (multi-TRPs) operation.

According to an example embodiment of FIG. 4, the at least one power reduction value for the at least one beam pair may comprise at least one Power Management-Maximum Power Reduction (P-MPR) value.

According to an example embodiment of FIG. 4, the at least one power reduction value may comprise at least one of: a power reduction value for a beam of the at least one beam pair; a power reduction value for each beam of at least one beam pair; or a joint power reduction value for the at least one beam pair.

According to an example embodiment of FIG. 4, each beam of the at least one beam pair may comprise or may be associated with a reference signal or a transmission configuration indication (TCI) state.

According to an example embodiment of FIG. 4, the receiving, by the network node from the user device in a wireless network, the maximum permissible exposure (MPE) report comprising the at least one power reduction value for the at least one beam pair may comprise at least one of the following: receiving the MPE report comprising power reduction values of a first beam and a second beam for a beam pair of the at least one beam pair, wherein the beam pair comprises the first beam and the second beam; receiving the MPE report comprising at least one power reduction value for a beam pair of the at least one beam pair, if at least one beam of the beam pair has a power reduction value greater than a first threshold or less than a second threshold; or receiving the MPE report comprising a joint power reduction value for a beam pair of the at least one beam pair, wherein the joint power reduction value is or is based on at least one of: 1) a sum of power reduction values of beams of the beam pair, 2) a maximum or a minimum or a highest or lowest power reduction value of the power reduction values of beams of the beam pair, 3) a power reduction value for one beam of the beam pair and a power reduction offset for other beam of the beam pair, and/or 4) a function or relationship of two power reduction values of beams of the beam pair.

According to an example embodiment of FIG. 4, the MPE report may comprise at least one of the following: for each beam pair of the at least one beam pair, an indication of whether at least one power reduction value is comprised in the MPE report for the beam pair; or a number of beam pairs of the at least one beam pair for which at least one power reduction value is comprised in the MPE report.

According to an example embodiment of FIG. 4, the method may further comprise transmitting, by the network node to the user device, control information indicating a beam pair of the at least one beam pair to be used for simultaneous uplink transmissions; and receiving, by the network node and from the user device, a transmission via a beam of the indicated beam pair.

Further details and/or example embodiments will now be described.

As noted above, the UE (or user device) may: select, by a user device (or UE) in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation. This selecting (or selection) by the UE of one or more beam pairs may be performed, for example, based on: 1) determining a set of beam pairs, wherein each beam pair of the set of beam pairs includes at least one of: beams corresponding to different panels or capability value sets, beams that are to be used by the user device to transmit simultaneous uplink transmissions, or beams that are to be used by the user device for multiple transmission-reception points (multi-TRPs) operation (e.g., to transmit to multiple TRPs); and 2) selecting, by the user device, one or more beam pairs among the set of beam pairs. The operations of 1) determining a set of beam pairs and 2) selecting one or more beam pairs among the set of beam pairs may be performed according to various rules implemented by the UE and/or based on one or more indications received by the UE from the gNB.
1) Determining a set of beam pairs: The UE may obtain or determine a set of beam pairs based on at least one of the following ways: (Examples A)-C) below are several examples and other techniques may be used as well):
   A) UE may be configured/indicated by the gNB (via RRC (radio resource control) message, MAC CE (media access control-control element), and/or DCI (downlink control information) or other signaling or message from the gNB) with one or more pairs of downlink reference signals, beams, TCI states or sounding reference signal resources intended for simultaneous (or overlapping in time) UL transmissions, or UL repetitions (where same information may be sent on each beam of the pair) or even for multi-TRP or multi-panel transmissions.
   B) Or, for example, the UE may be configured with (or may otherwise determine) a pool of beams or reference signals that may be used for (or may at least be candidates to be used for) simultaneous uplink transmissions, or multi-TRPs operation (e.g., for transmissions to multiple transmission-reception points (multi-TRPs)), or transmissions via beams corresponding to different panels or capability value sets. The UE may divide or separate the beams of a configured pool of beams into subsets, where each subset of beams may correspond to a corresponding panel or capability value set, for example. For example, a first subset of beams, from the pool of beams, may correspond to a first panel or a first capability value set, while a second subset of beams from the pool may correspond to a second panel (e.g., antenna panel) or value set. And the UE may then further group the beams from different subsets into beam pairs, where each beam pair may include one beam from each of the two subsets, so that each beam pair may include a first beam corresponding to a first panel or capability value set and a second beam corresponding to a second panel or capability value set, e.g., for (or to allow) simultaneous transmissions or multi-TRP operation (e.g., transmissions to multiple TRPs) using the beams of the beam pair (multi-TRPs operation). For example, the UE may establish or define a plurality of beam pairs, where each beam pair includes a beam from the first subset of beams and a beam from the second subset of beams, e.g., such that each beam pair, if used by the UE for UL transmission, may be used for simultaneous transmissions, transmissions to multiple TRPs (multi-TRPs operation), or transmissions via beams corresponding to the different panels or capability value sets. In this manner, a set of beam pairs may be determined by the UE, where each beam pair may be used for simultaneous (or overlapping in time) UL transmissions/repetitions or even for multi-TRP/multi-panel transmission operation, for example.
   C) The UE may be configured (e.g., by receiving a control information from the gNB) with two pools or sets of beams (e.g., one pool per TRP or CORESETpool index or CORESET group or SRS resource set or beam-failure detection reference signal set or subset) where the UE may pair the beams from each pool according to UE uplink simultaneous transmissions (e.g., such as for transmissions to M-TRPs). Additionally, the UE may determine from these pools, beams that cannot be used for simultaneous UL transmission operation, e.g., such beams may only be used for multi-TRP TDM PUSCH repetition/transmission operation, and those beams that cannot be used for simultaneous UL transmissions may be discarded. The remaining beams (which are to be used for simultaneous UL transmissions or multi-TRP operation) may be paired, e.g., with each beam pair including a beam from each pool or set, for example. The UE may then report MPE for at least some of these beams. The UE may transmit a MPE report that includes a power reduction value for at least one of these beam pairs.
2) selecting, by the user device, one or more beam pairs among the set of beam pairs: The UE may select one or more beam pairs, among the set of beam pairs, based on one or more of the following illustrative examples (e.g., where at least one power reduction value for at least one of these selected beam pairs, and possibly other information, may be reported in the MPE report):
   A) For at least one beam pair of the set, the UE may report, per beam pair, two power reduction (e.g., P-MPR) values for the beam pair, including a first power reduction value for a first beam and a second power reduction value for a second beam of the beam pair. Thus, in this example, the UE may report P-MPR values for both beams of a beam pair, for one or more (e.g., or even all) of the beam pairs of the set of beam pairs.
   B) The UE may be configured by the gNB to report a power reduction value(s) (e.g., one or more P-MPR values) for a beam pair if at least one beam in the beam pair has a power reduction (e.g., P-MPR) value above or below a certain threshold. For example, the UE may determine a P-MPR value for each beam of one or more beam pairs of the set of beam pairs, and then compare the P-MPR to one or more thresholds. For example, the UE may report at least one P-MPR value for a beam pair if a P-MPR value of at least one beam (or, alternatively, if the P-MPR values of both beams) of the beam pair is less than a first threshold, or alternatively, greater than a second threshold. This may allow the UE to select one or more beam pairs, within the set of beam pairs, for which a power reduction (e.g., P-MPR) value(s) may or will be reported to the gNB within the MPE report.
   C) The UE may be configured to report a power reduction value (e.g., P-MPR value) of a beam in a pair if this beam has a power reduction value that is below or above a certain threshold. In this example, the UE may indicate whether one or both beams in the pair have their power reduction values (P-MPR) reported and/or if it is the same P-MPR value. This MPE report may indicate which of the beam of the beam pair has a power reduction value that is above or below a threshold.
   D) The UE may report a joint power reduction (e.g., P-MPR) value for the beams in a beam pair, where the joint P-MPR value may be capturing, may include, or may be based on, for example: (i) the sum of the P-MPR values (for the beams of the beam pair), (ii) a maximum or a minimum (or a highest or lowest) between the two P-MPR values of the beams of the beam pair, (iii) a P-MPR value (a maximum or minimum, or a highest or a lowest P-MPR value) of one beam of the beam pair and an offset value for the other one beam of the beam pair (positive or negative), or (iv) any function or relationship (e.g., a mathematical relationship, or other relationship) of the P-MPR values for the beams of the beam pair (e.g., an average of the P-MPR values of the beams in the beam pair; a normalized average P-MPR value, a difference of the P-MPR values for the beam pair, or other function or relationship between P-MPR values of the beams of a beam pair).
   E) The UE may indicate whether a pair has MPE reporting and/or the number of beam pairs having their P-MPR values reported (or indicated within the MPE report). This could be achieved e.g. using a bit-field or a bit-map, e.g., where a bit set to 1 (P-MPR value(s) of the beam pair is reported) or a zero (e.g., indicating no P-MPR value(s) for this beam pair is reported) for each of the beam pairs in the set of beam pairs, to indicate which beam pairs have a power reduction (e.g., P-MPR) value(s) reported or included in the MPE report.

In an example embodiment, the example MPE reporting operation may be applicable, or may be performed, e.g., if simultaneous (or overlapping in time) UL transmissions/repetitions is applicable or configured/indicated for a UE (in a CC (component carrier) or BWP (bandwidth part)) or if multi-TRP operation (UE transmissions to multiple TRPs) or multi-panel transmissions (UE transmissions via beams corresponding to different panels or capability value sets) has been configured or may be performed by the UE.

Also, according to an example embodiment, the MPE reporting operation may be applicable or may be performed by the UE when (e.g., such as only when) a UE is scheduled or configured with or for simultaneous (or overlapping in time) UL transmissions or configured or scheduled for multi-TRP operation or multi-panel transmissions. Thus, in this situation (where the UE is configured or scheduled to perform such simultaneous transmissions, multi-TRP operation, or multi-panel transmissions), the gNB may have a need or use for power reduction values for one or more beam pairs that accommodate or allow the UE to perform such simultaneous transmission via beams of the beam pair, e.g., to allow the gNB (based on a received MPE report for one or more beam pairs) to indicate/configure the UE to use one of the reported beam pairs for simultaneous UL transmissions (or for multi-TRP operation or multi-panel transmissions), and thereby improve UL (uplink) performance and/or reduce radio link failures between the UE and gNB after a MPE event at the UE. Thus, by the UE reporting a power reduction (e.g., P-MPR) value(s) for one or more beam pairs of the set of beam pairs (e.g., where each beam of a beam pair may be used to perform simultaneous transmissions, multi-TRP operation or transmission via beams corresponding to different panels or capability value sets), the MPE report may enable improved radio performance for UL communication, e.g., in the case of a MPE event at the UE.

Alternatively, the UE may send an MPE report to the gNB after (e.g., only after), or in response to, the gNB sending (and UE receiving) an indication or instruction to the UE (e.g., via MAC CE or DCI) that instructs the UE to perform MPE reporting for at least one (or multiple) UL operation, e.g., which may be an indication that instructs the UE to perform MPE reporting to support multiple UL transmissions (or MPE reporting to support multi-TRP operation or multi-panel transmissions). The receipt of such instruction or indication from the gNB (request to send a MPE report) may trigger or cause the UE to measure P-MPR values for beams of the set of beam pairs, and then send the MPE report that includes power reduction value(s) (P-MPR value(s)) for at least one beam pair of the set of beam pairs.

The MPE report, including the various indications (if any), may be performed via MAC CE (MAC control element) using new or existing fields/bits. Alternatively, or additionally, this MPE reporting (including the various proposed indications, if any) may be performed as part of uplink control information carried on PUCCH or PUSCH (e.g., the MPE report may be included within uplink control information (UCI) included within PUCCH, or piggy-backed or multiplexed onto PUSCH, for example).

As additional or alternative aspects, the MPE reporting may be enhanced as follows: UE may receive an indication of a set of beams which are to be used for MPE reporting (e.g., same pool as Rel-17) and may further receive an indication to enable MPE reporting for more than one UL operation mode (e.g., an indication or instruction from gNB that enables or triggers the UE to perform MPE reporting for simultaneous transmissions, multi-TRP operation (e.g., transmissions by UE to multiple TRPs), and/or multi-panel transmissions (transmissions by UE via beams corresponding to different panels or capability value sets).

UE may determine reporting of MPEs to support one or more than one UL operation modes, e.g., overlapping/partial overlapping in time UL (or simultaneous UL transmission mode), time division multiplexed UL (multi-TRP) transmissions, or single-TRP UL.

UE may report MPE with corresponding beam or downlink reference signal index (N=1, . . . , X) for a first UL operation and may report beam pairs or downlink reference signal pairs (M=1, . . . , Y) for a second UL operation, where UL operation and corresponding beams/beam pairs may be indicated in the same MPE report.

In one alternative, the existing Rel-17 (and Rel-16) MPE reporting may be enhanced as follows (or enhanced to include one or more of the following features): an indication may be provided in MPE report that indicates which one of the two beams is under MPE, or both; in case that one of the beams is under MPE, the candidate beams reported by the UE in MPE report are candidates for the beam reported under MPE; in case the UE reports both current uplink beams under MPE (or common MPE issue), the candidate beams may be grouped so that half of the reported candidate beams are for the first uplink beam and the other half for the second uplink beam.

In yet another aspect or alternative, UE may, in addition to beam reporting of one or more downlink reference signals (DL RSs) (e.g., SSB reference signals and/or CSI-RS reference signals) and corresponding capability value set index(es) (or panels) and L1-RSRP values (or L1-SINR (signal to interference plus noise ratio)), report power reduction (e.g., P-MPR) value(s) for beams that are to be used for simultaneous UL transmission operation (and/or for multi-TRP TDM UL transmission/repetition operation and/or any other UL operation) where these beams may be only from the reported beams (e.g., for the reported SSBRI(s) and/or CRI(s)); similar conditions and/or indications as proposed above may also be used here to decide whether to report MPE for a beam or pair of beams. The MPE reporting, including the various proposed indications (if any), may be reported in the beam report. Alternatively, the MPE reporting, including the various proposed indications (if any), may be separately reported. For example, this MPE reporting may serve as indication to the gNB about whether, e.g., simultaneous UL transmission operation (or any other UL operation) may be feasible/suitable or not (using certain beams), e.g., in the case of MPE event at the UE. Note that, in addition to the condition for beam reporting (e.g., L1-RSRP value above a threshold etc.), MPE related condition may be considered, separately or jointly with L1-RSRP or L1-SINR, to also decide whether there should be reporting for a beam or pair of beams.

Although the focus so far has been described with respect to beam pairs, the described techniques and example operations may be more generally applied to subsets of beams where each subset includes more than two beams (e.g., three beams, four beams, . . . ).

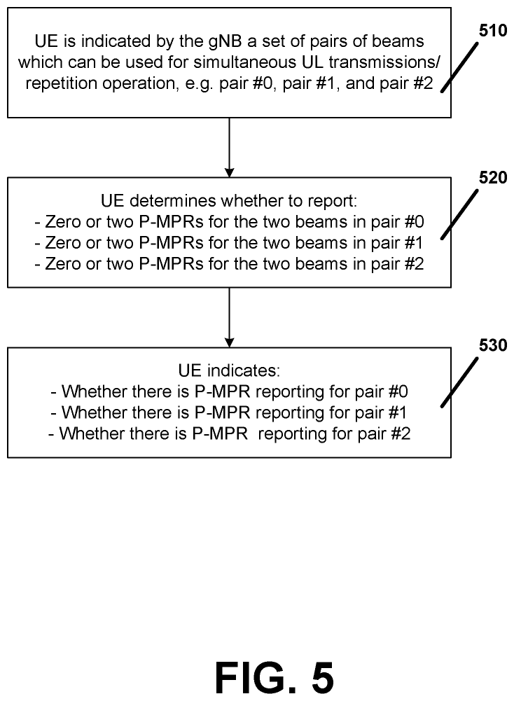

FIG. 5 is a flow chart illustrating operation of a UE according to another example embodiment. At operation 510, the UE receives an indication from the gNB of a set of beam pairs that can be (or are to be) used for simultaneous UL transmissions (or multi-TRP operation or multi-panel transmissions), e.g., beam pair #0, beam pair #1 and beam pair #3. At operation 520, the UE determines (e.g., based on the various rules or indications described above) whether to report: zero, one or two P-MPR values for beams in beam pair #0, zero, one or two P-MPR values for beams of beam pair #1, and zero, one or two P-MPR values for beams of beam pair #2. For example, based on a rule or indication, the UE may report a P-MPR value(s) for each beam pair, of the set of beam pairs, if a beam of such beam pair has a P-MPR that is less than a threshold (or other rule). At 530, the UE may indicate or include within the MPE report an indication (e.g., via bitmap) of whether P-MPR values are included for each of beam pairs #0, #1, #2, etc. For example, in the bit map, a 1 may indicate that a P-MPR value is provided in the MPE report for the corresponding beam pair, while a 0 in the bitmap may indicate that no P-MPR value is included in the MPE report for the corresponding beam pair. The UE may send the MPE report to the gNB, including the P-MPR value(s) for one or more beam pairs, and information indicating for which beam pairs P-MPR values are provided.

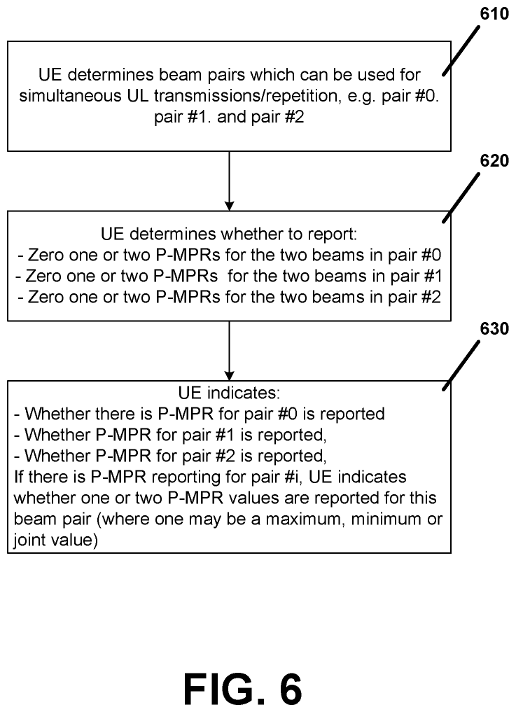

FIG. 6 is a flow chart illustrating operation of a UE according to another example embodiment. At 610, the UE may determine (e.g., may receive an indication or configuration from the gNB indicating) which beam pairs can be used for simultaneous UL transmissions (or can be used for multi-TRP operation or transmissions via beams corresponding to different panels or capability value sets), e.g., beam pair #0, beam pair #1 and beam pair #2. At 620, the UE determines whether to report (e.g., based on one or more rules or indications), zero, one or two P-MPR values for the beams of each of beam pairs #0, #1 and #2. At 630, the UE provides a MPE report to the gNB, and this MPE report may include the P-MPR values of one or more of the beam pairs, and may also include information indicating, e.g.: whether there is a P-MPR value for beam pair #0, beam pair #1, and/or beam pair #2. If there is P-MPR value(s) reported for beam pair #i, the UE may indicate whether one, or two P-MPR values are reported for this beam pair (e.g., such as in a case where one P-MPR value that is reported, the P-MPR value may be provided as a normal P-MPR value, or joint P-MPR value, or a maximum or minimum P-MPR value for the beams of the beam pair, for example).

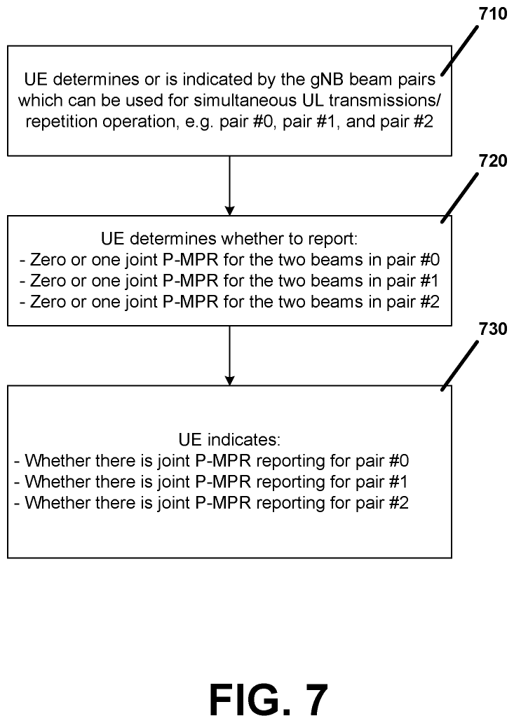

FIG. 7 is a flow chart illustrating operation of a UE according to yet another example embodiment. FIG. 7 is similar to FIG. 6, but in FIG. 7 the reporting and indications included within the MPE report are provided or performed for joint P-MPR values. At 710, the UE may determine (e.g., may receive an indication or configuration from the gNB indicating) which beam pairs can be used for simultaneous UL transmissions (or can be used for multi-TRP operation or transmissions via beam corresponding to different panels or capability value sets), e.g., beam pair #0, beam pair #1 and beam pair #2. At 720, the UE determines whether to report (e.g., based on one or more rules or indications), zero, or one P-MPR value for each of beam pairs #0, #1 and #2. At 730, the UE provides a MPE report to the gNB, and this MPE report may include a joint P-MPR value of one or more of the beam pairs, and may also include information indicating whether there is a joint P-MPR value for each of the beam pairs #0, #1 and #2.

Some example advantages may include:
Improved UL communication performance or reduced radio link failures between UE and gNB may be achieved, at least in some cases, based on the MPE report that may indicate a power reduction (e.g., P-MPR) value(s) for one or more beam pairs, where the beams of the beam pairs may be used to perform simultaneous UL transmissions, perform transmissions to multiple TRPs (multi-TRP operation), and/or perform transmissions via beams corresponding to different panels or capability value sets;

Providing the gNB with enhanced MPE knowledge in such a way to enable the gNB to make informed decisions as to whether simultaneous UL transmissions/repetition operations (or multi-TRP operation or multi-panel transmission/repetitions) may be configured or scheduled for the UE or not, based on a MPE event at the UE.

The MPE report may indicate UL power imbalance from UE due to MPE events.

The MPE report may provide the UE assistance to network node for a more robust M-TRP (multi-TRP) configuration of simultaneous UL transmissions when UE is experiencing MPE. This MPE report may also improve load balancing.

Some further examples will be described:

Example 1. A method comprising: selecting, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and
transmitting, by the user device to a network node in the wireless network, a maximum permissible exposure (MPE) report comprising at least one power reduction value for at least one of the selected one or more beam pairs.

Example 2. The method of example 1, wherein the selecting the one or more beam pairs comprises: determining a set of beam pairs, wherein each beam pair of the set of beam pairs comprises at least one of: beams corresponding to different panels or capability value sets, beams that are to be used by the user device for simultaneous uplink transmissions, or beams that are to be used by the user device for multiple transmission-reception points (multi-TRPs) operation; and selecting, by the user device, the one or more beam pairs among the set of beam pairs.

Example 3. The method of example 2, wherein: the determining the set of beam pairs is performed by the user device based on a first indication from the network node or based on one or more first rules; and the selecting the one or more beam pairs among the set of beam pairs is performed by the user device based on a second indication from the network node or based on one or more second rules.

Example 4. The method of any of examples 1-3, wherein the at least one power reduction value for the at least one of the selected one or more beam pairs comprises at least one Power Management-Maximum Power Reduction (P-MPR) value.

Example 5. The method of any of examples 1-4, wherein the at least one power reduction value comprises at least one of: a power reduction value for one of beams of at least one beam pair of the selected one or more beam pairs; a power reduction value for each beam of at least one beam pair of the selected one or more beam pairs; or a joint power reduction value for at least one beam pair of the selected one or more beam pairs.

Example 6. The method of any of examples 1-5, wherein each beam of a beam pair comprises or is associated with a reference signal or a transmission configuration indication (TCI) state.

Example 7. The method of any of examples 3-6, wherein the determining the set of beam pairs based on the first indication from the network node or based on the one or more first rules comprises: receiving, by the user device and from the network node, a configuration or the first indication that indicates the set of beam pairs, wherein each beam pair of the set of beam pairs comprises at least one of: beams corresponding to different panels or capability value sets, beams that are to be used by the user device for simultaneous uplink transmissions, or beams that are to be used by the user device for multiple transmission-reception points (multi-TRPs) operation.

Example 8. The method of any of examples 3-6 wherein the determining, based on the first indication from the network node or based on the one or more first rules, the set of beam pairs comprises: determining, by the user device, a first subset of beams associated with a first panel or capability value set, and a second subset of beams associated with a second panel or capability value set; and determining the set of beam pairs, wherein each beam pair of the set of beam pairs comprises a beam from the first subset of beams and a beam from the second subset of beams.

Example 9. The method of example 8, wherein the determining, based on the first indication from the network node or based on the one or more first rules, the first subset of beams and the second subset of beams comprises: receiving, by the user device from the network node, information or a configuration indicating a pool of beams; and separating beams, by the user device among the pool of beams, into the first subset of beams associated with the first panel or capability value set, and the second subset of beams associated with the second panel or capability value set.

Example 10. The method of example 8, wherein the determining, based on the first indication from the network node or based on the one or more first rules, the first subset of beams and the second subset of beams comprises: receiving, by the user device from the network node, information or a configuration indicating the first subset of beams associated with the first panel or capability value set, and the second subset of beams associated with the second panel or capability value set.

Example 11. The method of any of examples 1-3, wherein the selecting the one or more beam pairs among the set of beam pairs based on the second indication from the network node or based on the one or more second rules comprises performing at least one of the following: selecting beam pairs of the set of beam pairs; selecting a beam pair, within the set of beam pairs, if at least one beam in the beam pair has a power reduction value above or below a threshold; or selecting a beam pair, within the set of beam pairs, if beams in the beam pair have power reduction values above or below a threshold selecting a beam pair, within the set of beam pairs, if beams in the beam pair have a joint power reduction value above or below a threshold.

Example 12. The method of any of examples 1-11, wherein the transmitting, by the user device to the network node, the maximum permissible exposure (MPE) report comprising the at least one power reduction value for the at least one of the selected one or more beam pairs comprises at least one of the following: transmitting the MPE report comprising power reduction values of a first beam and a second beam for a beam pair of the at least one of the selected one or more beam pairs, wherein the beam pair comprises the first beam and the second beam; transmitting the MPE report comprising at least one power reduction value for a beam pair of the at least one of the selected one or more beam pairs, if at least one beam of the beam pair has a power reduction value greater than a first threshold or less than a second threshold; transmitting the MPE report comprising a joint power reduction value for a beam pair of the at least one of the selected one or more beam pairs, wherein the joint power reduction value is based on at least one of: 1) a sum of power reduction values of beams of the beam pair, 2) a maximum or a minimum or a highest or lowest power reduction value of the power reduction values of beams of the beam pair, 3) a power reduction value for one beam of the beam pair and a power reduction offset for other beam of the beam pair, and/or 4) a function or relationship of two power reduction values of beams of the beam pair.

Example 13. The method of any of examples 1-12, wherein the MPE report comprises at least one of the following: for a beam pair of the at least one of the selected one or more beam pairs, an indication of whether at least one power reduction value is comprised in the MPE report for the beam pair; or a number of beam pairs of the at least one of the selected one or more beam pairs for which at least one power reduction value is comprised in the MPE report.

Example 14. The method of any of examples 1-13, further comprising: receiving, by the user device and from the network node, control information indicating one of the at least one of the selected one or more beam pairs to be used for simultaneous uplink transmissions; performing, by the user device and based on the indicated beam pair, at least one of the following: performing, by the user device, simultaneous uplink transmissions using beams of the indicated beam pair; performing, by the user device, uplink transmissions to multiple transmission-reception points (multi-TRPs) using beams of the indicated beam pair; performing, by the user device, uplink transmissions via beams of the indicated beam pair, wherein the beams of the beam pair correspond to different panels or capability value sets.

Example 15. An apparatus comprising: at least one processor; and at least one memory including computer program code; the at least one memory and the computer program code configured to, with the at least one processor, cause the apparatus at least to: select, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and transmit, by the user device to a network node in the wireless network, a maximum permissible exposure (MPE) report comprising at least one power reduction value for at least one of the selected one or more beam pairs.

Example 16. The apparatus of example 15, wherein the at least one processor and the computer program code configured to cause the apparatus to select comprises the at least one processor and the computer program code configured to cause the apparatus to: determine a set of beam pairs, wherein each beam pair of the set of beam pairs comprises at least one of: beams corresponding to different panels or capability value sets, beams that are to be used by the user device for simultaneous uplink transmissions, or beams that are to be used by the user device for multiple transmission-reception points (multi-TRPs) operation; and select, by the user device, the one or more beam pairs among the set of beam pairs.

Example 17. The apparatus of example 16, wherein: the at least one processor and the computer program code configured to cause the apparatus to determine the set of beam pairs comprises the at least one processor and the computer program code configured to cause the apparatus to determine the set of beam pairs based on a first indication from the network node or based on one or more first rules; and the at least one processor and the computer program code configured to cause the apparatus to select the set of beam pairs comprises the at least one processor and the computer program code configured to cause the apparatus to select the one or more beam pairs among the set of beam pairs based on a second indication from the network node or based on one or more second rules.

Example 18. The apparatus of any of examples 15-17, wherein the at least one power reduction value for the at least one of the selected one or more beam pairs comprises at least one Power Management-Maximum Power Reduction (P-MPR) value.

Example 19. The apparatus of any of examples 15-18, wherein the at least one power reduction value comprises at least one of: a power reduction value for one of beams of at least one beam pair of the selected one or more beam pairs; a power reduction value for each beam of at least one beam pair of the selected one or more beam pairs; or a joint power reduction value for at least one beam pair of the selected one or more beam pairs.

Example 20. The apparatus of any of examples 15-19, wherein each beam of a beam pair comprises or is associated with a reference signal or a transmission configuration indication (TCI) state.

Example 21. The apparatus of any of examples 17-20, wherein the at least one processor and the computer program code configured to cause the apparatus to determine the set of beam pairs based on the first indication from the network node or based on the one or more first rules comprises the at least one processor and the computer program code configured to cause the apparatus to: receive, by the user device from the network node, a configuration or the first indication that indicates the set of beam pairs, wherein each beam pair of the set of beam pairs comprises at least one of: beams corresponding to different panels or capability value sets, beams that are to be used by the user device for simultaneous uplink transmissions, or beams that are to be used by the user device for multiple transmission-reception points (multi-TRPs) operation.

Example 22. The apparatus of any of examples 17-20 wherein the at least one processor and the computer program code configured to cause the apparatus to determine the set of beam pairs based on the first indication from the network node or based on the one or more first rules comprises the at least one processor and the computer program code configured to cause the apparatus to: determine, by the user device, a first subset of beams associated with a first panel or capability value set, and a second subset of beams associated with a second panel or capability value set; and determine the set of beam pairs, wherein each beam pair of the set of beam pairs comprises a beam from the first subset of beams and a beam from the second subset of beams.

Example 23. The apparatus of example 22, wherein the at least one processor and the computer program code configured to cause the apparatus to determine, based on the first indication from the network node or based on the one or more first rules, the first subset of beams and the second subset of beams comprises the at least one processor and the computer program code configured to cause the apparatus to: receive, by the user device from the network node, information or a configuration indicating a pool of beams; and separate beams, by the user device among the pool of beams, into the first subset of beams associated with the first panel or capability value set, and the second subset of beams associated with the second panel or capability value set.

Example 24. The apparatus of example 22, wherein the at least one processor and the computer program code configured to cause the apparatus to determine, based on the first indication from the network node or based on the one or more first rules, the first subset of beams and the second subset of beams comprises the at least one processor and the computer program code configured to cause the apparatus to: receive, by the user device from the network node, information or a configuration indicating the first subset of beams associated with the first panel or capability value set, and the second subset of beams associated with the second panel or capability value set.

Example 25. The apparatus of any of examples 15-17, wherein the at least one processor and the computer program code configured to cause the apparatus to select the one or more beam pairs among the set of beam pairs based on the second indication from the network node or based on the one or more second rules comprises the at least one processor and the computer program code configured to cause the apparatus to perform at least one of the following: select beam pairs of the set of beam pairs; select a beam pair, within the set of beam pairs, if at least one beam in the beam pair has a power reduction value above or below a threshold; select a beam pair, within the set of beam pairs, if beams in the beam pair have power reduction values above or below a threshold; or select a beam pair, within the set of beam pairs, if beams in the beam pair have a joint power reduction value above or below a threshold.

Example 26. The apparatus of any of examples 15-25, wherein the at least one processor and the computer program code configured to cause the apparatus to transmit, by the user device to a network node, the maximum permissible exposure (MPE) report comprising the at least one power reduction value for the at least one of the selected one or more beam pairs comprises the at least one processor and the computer program code configured to cause the apparatus to perform at least one of the following: transmit the MPE report comprising power reduction values of a first beam and a second beam for a beam pair of the at least one of the selected one or more beam pairs, wherein the beam pair comprises the first beam and the second beam; transmit the MPE report comprising the at least one power reduction value for the beam pair of the at least one of the selected one or more beam pairs, if at least one beam of the beam pair has a power reduction value greater than a first threshold or less than a second threshold; or transmit the MPE report comprising a joint power reduction value for a beam pair of the at least one of the selected one or more beam pairs, wherein the joint power reduction value is based on at least one of: 1) a sum of power reduction values of beams of the beam pair, 2) a maximum or a minimum or a highest or lowest power reduction value of the power reduction values of beams of the beam pair, 3) a power reduction value for one beam of the beam pair and a power reduction offset for other beam of the beam pair, and/or 4) a function or relationship of two power reduction values of beams of the beam pair.

Example 27. The apparatus of any of examples 15-26, wherein the MPE report comprises at least one of the following: for a beam pair of the at least one of the selected one or more beam pairs, an indication of whether at least one power reduction value is comprised in the MPE report for the beam pair; or a number of beam pairs of the at least one of the selected one or more beam pairs for which at least one power reduction value is comprised in the MPE report.

Example 28. The apparatus of any of examples 15-27, wherein the at least one processor and the computer program code are further configured to cause the apparatus to: receive, by the user device and from the network node, control information indicating one of the at least one of the selected one or more beam pairs to be used for simultaneous uplink transmissions; and perform, by the user device and based on the indicated beam pair, at least one of the following: perform, by the user device, simultaneous uplink transmissions using beams of the indicated beam pair; perform, by the user device, uplink transmissions to multiple transmission-reception points (multi-TRPs) using beams of the indicated beam pair; or perform, by the user device, uplink transmissions via beams of the indicated beam pair, wherein the beams of the beam pair correspond to different panels or capability value sets.

Example 29. A non-transitory computer-readable storage medium comprising instructions stored thereon that, when executed by at least one processor, are configured to cause a computing system to: select, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and transmit, by the user device to a network node in the wireless network, a maximum permissible exposure (MPE) report comprising at least one power reduction value for at least one of the selected one or more beam pairs.

Example 30. An apparatus comprising: means for selecting, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and means for transmitting, by the user device to a network node in the wireless network, a maximum permissible exposure (MPE) report comprising at least one power reduction value for at least one of the selected one or more beam pairs.

Example 31. A method comprising: receiving, by a network node and from a user device in a wireless network, a maximum permissible exposure (MPE) report comprising at least one power reduction value for at least one beam pair; wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.

Example 32. The method of example 31, wherein the at least one power reduction value for the at least one beam pair comprises at least one Power Management-Maximum Power Reduction (P-MPR) value.

Example 33. The method of any of examples 31-32, wherein the at least one power reduction value comprises at least one of: a power reduction value for a beam of the at least one beam pair; a power reduction value for each beam of the at least one beam pair; or a joint power reduction value for the at least one beam pair.

Example 34. The method of any of examples 31-33, wherein each beam of the at least one beam pair comprises or is associated with a reference signal or a transmission configuration indication (TCI) state.

Example 35. The method of any of examples 31-34, wherein the receiving, by the network node and from the user device in a wireless network, the maximum permissible exposure (MPE) report comprising the at least one power reduction value for the at least one beam pair comprises at least one of the following: receiving the MPE report comprising power reduction values of a first beam and a second beam for a beam pair of the at least one beam pair, wherein the beam pair comprises the first beam and the second beam; receiving the MPE report comprising at least one power reduction value for a beam pair of the at least one beam pair, if at least one beam of the beam pair has a power reduction value greater than a first threshold or less than a second threshold; or receiving the MPE report comprising a joint power reduction value for a beam pair of the at least one beam pair, wherein the joint power reduction value is or is based on at least one of: 1) a sum of power reduction values of beams of the beam pair, 2) a maximum or a minimum or a highest or lowest power reduction value of the power reduction values of beams of the beam pair, 3) a power reduction value for one beam of the beam pair and a power reduction offset for other beam of the beam pair, and/or 4) a function or relationship of two power reduction values of beams of the beam pair.

Example 36. The method of any of examples 31-35, wherein the MPE report comprises at least one of the following: for a beam pair of the at least one beam pair, an indication of whether at least one power reduction value is comprised in the MPE report for the beam pair; or a number of beam pairs of the at least one beam pair for which at least one power reduction value is comprised in the MPE report.

Example 37. The method of any of examples 31-36, further comprising: transmitting, by the network node to the user device, control information indicating a beam pair of the at least one beam pair to be used for simultaneous uplink transmissions; and receiving, by the network node and from the user device, a transmission via a beam of the indicated beam pair.

Example 38. An apparatus comprising: at least one processor; and at least one memory including computer program code; the at least one memory and the computer program code configured to, with the at least one processor, cause the apparatus at least to: receive, by a network node and from a user device in a wireless network, a maximum permissible exposure (MPE) report comprising at least one power reduction value for at least one beam pair; wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.

Example 39. The apparatus of example 38, wherein the at least one power reduction value for the at least one beam pair comprises at least one Power Management-Maximum Power Reduction (P-MPR) value.

Example 40. The apparatus of any of examples 38-39, wherein the at least one power reduction value comprises at least one of: a power reduction value for a beam of the at least one beam pair; a power reduction value for each beam of the at least one beam pair; or a joint power reduction value for the at least one beam pair.

Example 41. The apparatus of any of examples 38-40, wherein each beam of the at least one beam pair comprises or is associated with a reference signal or a transmission configuration indication (TCI) state.

Example 42. The apparatus of any of examples 38-41, wherein the at least one processor and the computer program code configured to cause the apparatus to receive the maximum permissible exposure (MPE) report comprising the at least one power reduction value for the at least one beam pair comprises the at least one processor and the computer program code configured to cause the apparatus to perform at least one of the following: receive the MPE report comprising power reduction values of a first beam and a second beam for a beam pair of the at least one beam pair, wherein the beam pair comprises the first beam and the second beam; receive the MPE report comprising at least one power reduction value for a beam pair of the at least one beam pair, if the beam pair has a power reduction value greater than a first threshold or less than a second threshold; or receive the MPE report comprising a joint power reduction value for a beam pair of the at least one beam pair, wherein the joint power reduction value is based on at least one of: 1) a sum of power reduction values of beams of the beam pair, 2) a maximum or a minimum or a highest or lowest power reduction value of the power reduction values of beams of the beam pair, 3) a power reduction value for one beam of the beam pair and a power reduction offset for other beam of the beam pair, and/or 4) a function or relationship of two power reduction values of beams of the beam pair.

Example 43. The apparatus of any of examples 38-42, wherein the MPE report comprises at least one of the following: for a beam pair of the at least one beam pair, an indication of whether at least one power reduction value is comprised in the MPE report for the beam pair; or a number of beam pairs of the at least one beam pair for which at least one power reduction value is comprised in the MPE report.

Example 44. The apparatus of any of examples 38-43, wherein the at least one processor and the computer program code are further configured to cause the apparatus to: transmit, by the network node to the user device, control information indicating an indicated beam pair of the at least one beam pair to be used to transmit simultaneous uplink transmissions; and receive, by the network node and from the user device, a transmission via a beam of the indicated beam pair.

Example 45. A non-transitory computer-readable storage medium comprising instructions stored thereon that, when executed by at least one processor, are configured to cause a computing system to: receive, by a network node and from a user device in a wireless network, a maximum permissible exposure (MPE) report comprising at least one power reduction value for at least one beam pair; wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.

Example 46. An apparatus comprising: means for receiving, by a network node and from a user device in a wireless network, a maximum permissible exposure (MPE) report comprising at least one power reduction value for at least one beam pair; wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.

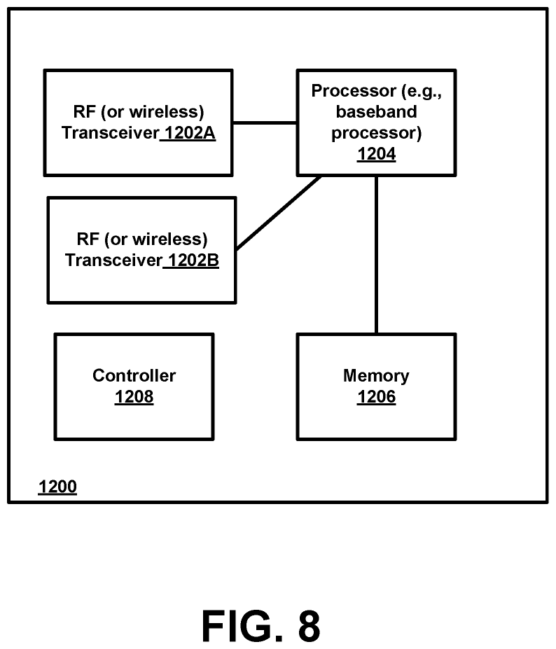

FIG. 8 is a block diagram of a network node (e.g., AP, BS, eNB, gNB, RAN node) 1200 according to an example embodiment. The wireless station 1200 may include, for example, one or more (e.g., two as shown in FIG. 8) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 8, a controller (or processor) 1208 may execute software and instructions, and may provide overall control for the station 1200, and may provide control for other systems not shown in FIG. 8, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers.

Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-46. (canceled)

47. A method comprising:
selecting, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and
transmitting, by the user device to a network node in the wireless network, a maximum permissible exposure (MPE) report comprising at least one power reduction value for at least one of the selected one or more beam pairs.

48. The method of claim 47, wherein the selecting the one or more beam pairs comprises:
determining a set of beam pairs, wherein each beam pair of the set of beam pairs comprises at least one of: beams corresponding to different panels or capability value sets, beams that are to be used by the user device for simultaneous uplink transmissions, or beams that are to be used by the user device for multiple transmission-reception points (multi-TRPs) operation; and
selecting, by the user device, the one or more beam pairs among the set of beam pairs.

49. The method of claim 48, wherein:
the determining the set of beam pairs is performed by the user device based on a first indication from the network node or based on one or more first rules; and
the selecting the one or more beam pairs among the set of beam pairs is performed by the user device based on a second indication from the network node or based on one or more second rules.

50. The method of claim 47, wherein the at least one power reduction value for the at least one of the selected one or more beam pairs comprises at least one Power Management-Maximum Power Reduction (P-MPR) value.

51. The method of claim 47, wherein the at least one power reduction value comprises at least one of:
a power reduction value for one of beams of at least one beam pair of the selected one or more beam pairs;
a power reduction value for each beam of at least one beam pair of the selected one or more beam pairs; or
a joint power reduction value for at least one beam pair of the selected one or more beam pairs.

52. An apparatus comprising:
at least one processor; and
at least one memory, the at least one memory storing instructions, that when executed by the at least one processor, cause the apparatus at least to:
select, by a user device in a wireless network, one or more beam pairs, wherein each beam pair comprises at least one of: beams corresponding to different panels or capability value sets, beams that are to be used by the user device for simultaneous uplink transmissions, or beams that are to be used by the user device for multiple transmission-reception points (multi-TRPs) operation; and
transmit, by the user device to a network node in the wireless network, a maximum permissible exposure (MPE) report comprising at least one power reduction value for at least one of the selected one or more beam pairs.

53. The apparatus of claim 52, wherein the instructions, when executed by the at least one processor, further cause the apparatus at least to:
determine a set of beam pairs, wherein each beam pair of the set of beam pairs comprises at least one of: beams corresponding to different panels or capability value sets, beams that are to be used by the user device for simultaneous uplink transmissions, or beams that are to be used by the user device for multiple transmission-reception points (multi-TRPs) operation; and
select, by the user device, the one or more beam pairs among the set of beam pairs.

54. The apparatus of claim 53, wherein the instructions, when executed by the at least one processor, further cause the apparatus at least to:
determine the set of beam pairs based on a first indication from the network node or based on one or more first rules; and
select the one or more beam pairs among the set of beam pairs based on a second indication from the network node or based on one or more second rules.

55. The apparatus of claim 54, wherein the instructions, when executed by the at least one processor, further cause the apparatus at least to:
receive, by the user device from the network node, a configuration or the first indication that indicates the set of beam pairs, wherein each beam pair of the set of beam pairs comprises at least one of: beams corresponding to different panels or capability value sets, beams that are to be used by the user device for simultaneous uplink transmissions, or beams that are to be used by the user device for multiple transmission-reception points (multi-TRPs) operation.

56. The apparatus of claims 54, wherein the instructions, when executed by the at least one processor, further cause the apparatus at least to:
determine, by the user device, a first subset of beams associated with a first panel or capability value set, and a second subset of beams associated with a second panel or capability value set; and
determine the set of beam pairs, wherein each beam pair of the set of beam pairs comprises a beam from the first subset of beams and a beam from the second subset of beams.

57. The apparatus of claim 56, wherein the instructions, when executed by the at least one processor, further cause the apparatus at least to:
receive, by the user device from the network node, information or a configuration indicating a pool of beams; and
separate beams, by the user device among the pool of beams, into the first subset of beams associated with the first panel or capability value set, and the second subset of beams associated with the second panel or capability value set.

58. The apparatus of claim 57, wherein the instructions, when executed by the at least one processor, further cause the apparatus at least to:
receive, by the user device from the network node, information or a configuration indicating the first subset of beams associated with the first panel or capability value set, and the second subset of beams associated with the second panel or capability value set.

59. The apparatus of claim 52, wherein the at least one power reduction value for the at least one of the selected one or more beam pairs comprises at least one Power Management-Maximum Power Reduction (P-MPR) value.

60. The apparatus of claim 52, wherein the at least one power reduction value comprises at least one of:
a power reduction value for one of beams of at least one beam pair of the selected one or more beam pairs;
a power reduction value for each beam of at least one beam pair of the selected one or more beam pairs; or
a joint power reduction value for at least one beam pair of the selected one or more beam pairs.

61. The apparatus of claim 52, wherein each beam of a beam pair comprises or is associated with a reference signal or a transmission configuration indication (TCI) state.

62. The apparatus of claim 52, wherein the instructions, when executed by the at least one processor, further cause the apparatus at least to:
select beam pairs of the set of beam pairs;
select a beam pair, within the set of beam pairs, if at least one beam in the beam pair has a power reduction value above or below a threshold;
select a beam pair, within the set of beam pairs, if beams in the beam pair have power reduction values above or below a threshold; or
select a beam pair, within the set of beam pairs, if beams in the beam pair have a joint power reduction value above or below a threshold.

63. The apparatus of claim 52, wherein the instructions, when executed by the at least one processor, further cause the apparatus at least to:
transmit the MPE report comprising power reduction values of a first beam and a second beam for a beam pair of the at least one of the selected one or more beam pairs, wherein the beam pair comprises the first beam and the second beam;
transmit the MPE report comprising the at least one power reduction value for the beam pair of the at least one of the selected one or more beam pairs, if at least one beam of the beam pair has a power reduction value greater than a first threshold or less than a second threshold; or
transmit the MPE report comprising a joint power reduction value for a beam pair of the at least one of the selected one or more beam pairs, wherein the joint power reduction value is based on at least one of: 1) a sum of power reduction values of beams of the beam pair, 2) a maximum or a minimum or a highest or lowest power reduction value of the power reduction values of beams of the beam pair, 3) a power reduction value for one beam of the beam pair and a power reduction offset for other beam of the beam pair, and/or 4) a function or relationship of two power reduction values of beams of the beam pair.

64. The apparatus of claim 52, wherein the MPE report comprises at least one of the following:
for a beam pair of the at least one of the selected one or more beam pairs, an indication of whether at least one power reduction value is comprised in the MPE report for the beam pair; or
a number of beam pairs of the at least one of the selected one or more beam pairs for which at least one power reduction value is comprised in the MPE report.

65. The apparatus of claim 52, wherein the instructions, when executed by the at least one processor, further cause the apparatus at least to:
receive, by the user device and from the network node, control information indicating one of the at least one of the selected one or more beam pairs to be used for simultaneous uplink transmissions; and
perform, by the user device and based on the indicated beam pair, at least one of the following:
perform, by the user device, simultaneous uplink transmissions using beams of the indicated beam pair;
perform, by the user device, uplink transmissions to multiple transmission-reception points (multi-TRPs) using beams of the indicated beam pair; or
perform, by the user device, uplink transmissions via beams of the indicated beam pair, wherein the beams of the beam pair correspond to different panels or capability value sets.

66. An apparatus comprising:
at least one processor; and
at least one memory, the at least one memory storing instructions, that when executed by the at least one processor, cause the apparatus at least to:
receive, by a network node and from a user device in a wireless network, a maximum permissible exposure (MPE) report comprising at least one power reduction value for at least one beam pair;
wherein the at least one beam pair comprises at least one of: beams corresponding to different panels or capability value sets, beams that are to be used by the user device for simultaneous uplink transmissions, or beams that are to be used by the user device for multiple transmission-reception points (multi-TRPs) operation.
